(19) United States
(12) Patent Application Publication
(10) Pub. No.: US 2023/0031518 A1
(43) Pub. Date: Feb. 2, 2023

(54) DEVICE OPERATIONAL MODE BLOCKING

(71) Applicant: Hewlett-Packard Development Company, L.P., Spring, TX (US)

(72) Inventors: Veera Venkata Paparao Gokavarapu, Bangalore (IN); Shinoj Bhaskaran, Bangalore (IN)

(21) Appl. No.: 17/649,122

(22) Filed: Jan. 27, 2022

(30) Foreign Application Priority Data
Jul. 30, 2021 (IN) 202141034443

(51) Int. Cl. G06F 3/12

(52) U.S. Cl. CPC G06F 3/1234; G06F 3/1259; G06F 3/1258; G06F 3/1255; G06F 3/1267; G06F 3/121

(57) ABSTRACT

Examples disclosed herein relate to detecting an error condition blocking an operational mode of a device, determining whether the operational mode will cause a loss of at least one data element, and in response to determining that the operational mode will cause a loss of at least one data element, storing a copy of the at least one data element and causing the device to enter the operational mode.

### BACKGROUND

Multi-function devices often combine different components such as a printer, scanner, and copier into a single device. Such devices frequently receive refills of consumables, such as print substances (e.g., ink, toner, and/or additive materials) and/or media (e.g., paper, vinyl, and/or other print substrates). In some situations, these devices may have different operational modes.

### BRIEF DESCRIPTION OF THE DRAWINGS

FIG. 1 is a block diagram of an example computing device for providing device operational mode blocking.

FIG. 2 is a flowchart of an example method for providing device operational mode blocking.

FIG. 3 is a block diagram of an example system for providing device operational mode blocking.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

Most multi-function-print devices (MFPs) provide several features, such as an option to scan a physical document, which may be controlled via an on-device control panel, a connected application, and/or a remote service. Other options may include printing, copying, faxing, document assembly, etc. The scanning portion of an MFP may comprise an optical assembly located within a sealed enclosure. The sealed enclosure may have a scan window through which the optical assembly can scan a document, which may be placed on a flatbed and/or delivered by a sheet feeder mechanism.

In some situations, it is desirable to operate a device and utilize its resources efficiently. For example, when not in active use, an MFP may switch to a low power operational mode that keeps some functions and/or components active while reducing or eliminating power to other functions and/or components. A fuser, for example, may be powered down in the device during such a low power operational mode while a network listening service may be configured to poll for available print jobs at a less frequent interval than in a full power operational mode.

Some error conditions, however, may block the device from switching between operational modes. In such occurrences, the efficiency of the device may be reduced, such as when an error blocks a change to a low power operational mode or, conversely, blocks the device from exiting the low power operational mode in a timely manner.

For example, a printing device may experience an empty media tray error condition while processing an active print job (e.g., out of paper). The printer may be stuck in a printing operational mode until the media tray is loaded with media. This may result in printing components, such as a printhead, fuser, media path elements, etc. remaining in a high power consumption mode rather than being able to switch to a low power operational mode. In some situations, even when some components may be switched to a low power operational mode, the device may need to maintain power to others, such as keeping volatile memory powered to avoid losing data associated with a job interrupted by the error condition.

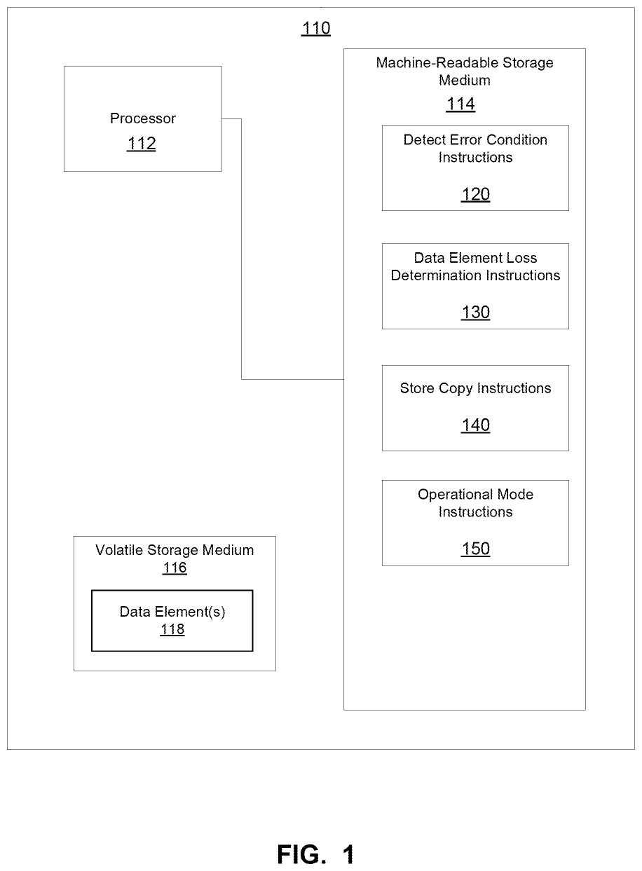

FIG. 1 is a block diagram of an example computing device 110 for providing device operational mode blocking. Computing device 110 may comprise a processor 112 and a non-transitory, machine-readable storage medium 114. Computing device 110 may further comprise a volatile storage medium 116 providing transitory storage for at least one data element 118. Storage medium 114 may comprise a plurality of processor-executable instructions, such as detect error condition instructions 120, data element loss determination instructions 130, store copy instructions 140, and operational mode instructions 150. In some implementations, instructions 120, 130, 140, 150 may be associated with a single computing device 110 and/or may be communicatively coupled among different computing devices such as via a direct connection, bus, or network.

Processor 112 may comprise a central processing unit (CPU), a semiconductor-based microprocessor, a programmable component such as a complex programmable logic device (CPLD) and/or field-programmable gate array (FPGA), or any other hardware device suitable for retrieval and execution of instructions stored in machine-readable storage medium 114. In particular, processor 112 may fetch, decode, and execute instructions 120, 130, 140, 150.

Executable instructions 120, 130, 140, 150 may comprise logic stored in any portion and/or component of non-transitory machine-readable storage medium 114 and executable by processor 112. The non-transitory machine-readable storage medium 114 may comprise a non-volatile memory such as non-volatile random access memory (NVRAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. The ROM may comprise, for example, a programmable read-only memory (PROM), an erasable programmable read-only memory (EPROM), an electrically erasable programmable read-only memory (EEPROM), and/or other like memory device. Storage medium 114 may comprise non-volatile memory that retains its stored contents when not powered and may not need to have its content refreshed.

The volatile storage medium 116 may comprise, for example, random access memory (RAM) such as static random access memory (SRAM), dynamic random access memory (DRAM), and/or magnetic random access memory (MRAM) and other such devices. Volatile memory may comprise a storage medium that only maintains its store of data content, such as data element(s) 118, while powered.

Detect error condition instructions 120 may detect an error condition blocking an operational mode of a device 110. The operational mode may, for example, comprise a power-saving mode. The error condition may comprise, for example, a lack of a consumable supply, a power condition, and/or a component failure. For example, a print job may be in process when a consumable supply error, such as running out of paper, occurs.

Data element loss determination instructions 130 may determine whether the operational mode will cause a loss of at least one data element 118. The at least one data element 118 may comprise, for example, data associated with a print job. For example, an active print job may be stored as data element 118 in volatile storage medium 116, and so may be lost if device 110 were to switch to a power-saving operational mode that reduced or eliminated power to volatile storage medium 116.

Store copy instructions 140 may, in response to determining that the operational mode will cause a loss of at least one data element 118, store a copy of the at least one data element 118. For example, store copy instructions 140 may copy the at least one data element 118 from a volatile memory location such as volatile storage medium 116 to a non-volatile memory location such as non-transitory machine-readable medium 114. In such implementations, the print job data associated with data element 118 may be copied to the non-volatile storage medium 118 so that power may be reduced or eliminated to volatile storage medium 116 without losing data such as the current job status.

Operational mode instructions 150 may cause the device 110 to enter the operational mode. For example, once data element 118 has been copied to the non-volatile storage medium, a low power operational mode may be entered that reduces power usage by various functions and/or components of device 110. The data element(s) 118 stored in volatile storage medium 116 may be lost when volatile storage medium 116 loses power, but the copy of data element(s) 118 in non-volatile storage medium 114 may be maintained even without power.

In some implementations, detect error condition instructions 120 may determine whether the error condition that blocked the operational mode has been corrected. For example, an out-of-paper error may be corrected by detecting that paper has been loaded into device 110. In response to determining that the error condition that blocked the operational mode has been corrected, operational mode instructions 150 may cause the device 110 to enter a second operational mode. For example, device 110 may switch from the low power operational mode to a job processing mode in order to resume printing the interrupted print job.

Further in response to determining that the error condition that blocked the operational mode has been corrected, store copy instructions 140 may restore the at least one data element 118 from the stored copy. For example, store copy instructions 140 may copy the stored data element from non-volatile storage medium 114 to volatile storage medium 116. In some implementations, a memory address of data element(s) 118 may be stored in the non-volatile storage medium 114 when the copy is stored so that data element(s) 118 may be restored to the same location in volatile storage medium 116 following the switch to the second operational mode. Following restoration of the at least one data element 118, store copy instructions 140 may delete the stored copy of the at least one data element 118. The second operational mode may comprise, for example, a processing mode associated with processing the at least one data element 118. For example, once device 110 switches to the processing mode and data element 118 has been restored to volatile storage medium 116, processing of the interrupted print job may resume.

In some implementations, the at least one data element 118 may comprise a user identifier. Store copy instructions 140 may notify a user associated with the user identifier that the copy of the at least one data element has been stored to avoid loss and/or restored and is ready to resume. For example, the user identifier may comprise and/or be associated with an email address. A message may be sent to the email address to inform the user that the job has been interrupted, that the job has been saved for later processing, that the data element 118 has been restored, and/or that job processing has resumed. In some implementations, the notification to the user may comprise details of the error condition so as to assist the user in rectifying the error condition.

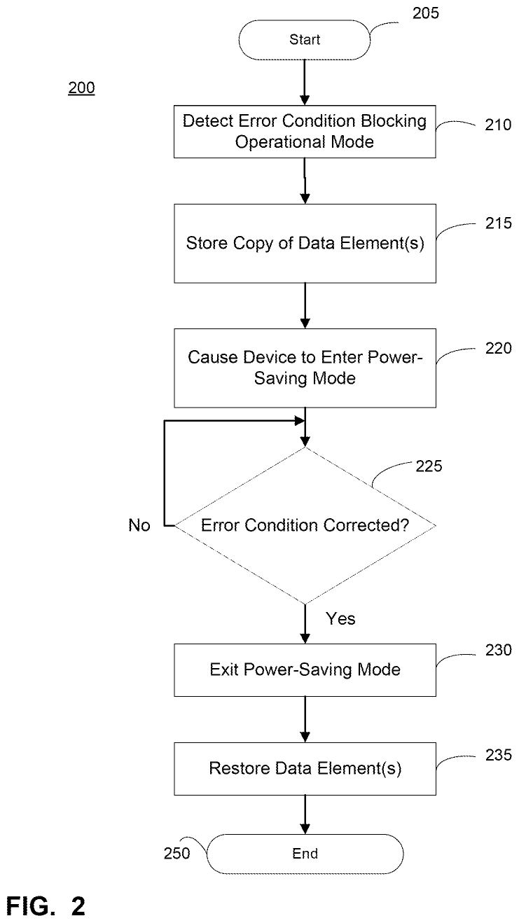

FIG. 2 is a flowchart of an example method 200 for device operational mode blocking. Although execution of method 200 is described below with reference to computing device 110, other suitable components for execution of method 200 may be used.

Method 200 may begin at stage 205 and advance to stage 210 where device 110 may detect an error condition blocking an operational mode of a device. For example, detect error condition instructions 120 may detect an error condition blocking an operational mode of a device 110. The operational mode may, for example, comprise a power-saving mode. The error condition may comprise, for example, a lack of a consumable supply, a power condition, and/or a component failure. For example, a print job may be in process when a consumable supply error, such as running out of paper, occurs.

Method 200 may then advance to stage 215 where computing device 110 may store a copy of each of a plurality of data elements. In some implementations, storing the copy of each of plurality of data elements may comprise copying each of the plurality of data elements from a volatile memory location to a non-volatile memory location. For example, store copy instructions 140 may, in response to determining that the operational mode will cause a loss of at least one data element 118, store a copy of the at least one data element 118. For example, store copy instructions 140 may copy the at least one data element 118 from a volatile memory location such as volatile storage medium 116 to a non-volatile memory location such as non-transitory machine-readable medium 114. In such implementations, the print job data associated with data element 118 may be copied to the non-volatile storage medium 118 so that power may be reduced or eliminated to volatile storage medium 116 without losing data such as the current job status.

Method 200 may then advance to stage 220 where computing device 110 may cause the device to enter a power-saving mode. For example, operational mode instructions 150 may cause the device 110 to enter the operational mode. For example, once data element 118 has been copied to the non-volatile storage medium, a low power operational mode may be entered that reduces power usage by various functions and/or components of device 110. The data element(s) 118 stored in volatile storage medium 116 may be lost when volatile storage medium 116 loses power, but the copy of data element(s) 118 in non-volatile storage medium 114 may be maintained even without power.

Method 200 may then advance to stage 225 where computing device 110 may determine whether the error condition that blocked the power-saving mode has been corrected. For example, detect error condition instructions 120 may determine whether the error condition that blocked the operational mode has been corrected. For example, an out-of-paper error may be corrected by detecting that paper has been loaded into device 110.

Method 200 may remain in stage 225 until the error condition is corrected.

In response to determining that the error condition that blocked the power-saving mode has been corrected, method 200 may advance to stage 230 where computing device 110 may exit the power-saving mode such as by executing operational mode instructions 150 to cause the device 110 to enter a second operational mode. For example, device 110 may switch from the low power operational mode to a job processing mode in order to resume printing the interrupted print job.

Method 200 may then advance to stage 235 where computing device 110 may restore the plurality of data elements from the stored copies of each of the plurality of data elements. In some implementations, restoring the plurality of data elements from the stored copies of each of the plurality of data elements may comprise restoring the plurality of data elements in an order according to a priority of each of the plurality of data elements. For example, store copy instructions 140 may restore the at least one data element 118 from the stored copy. For example, store copy instructions 140 may copy the stored data element from non-volatile storage medium 114 to volatile storage medium 116. In some implementations, a memory address of data element(s) 118 may be stored in the non-volatile storage medium 114 when the copy is stored so that data element(s) 118 may be restored to the same location in volatile storage medium 116 following the switch to the second operational mode. Following restoration of the at least one data element 118, store copy instructions 140 may delete the stored copy of the at least one data element 118. The second operational mode may comprise, for example, a processing mode associated with processing the at least one data element 118. For example, once device 110 switches to the processing mode and data element 118 has been restored to volatile storage medium 116, processing of the interrupted print job may resume.

Method 200 may then end at stage 250.

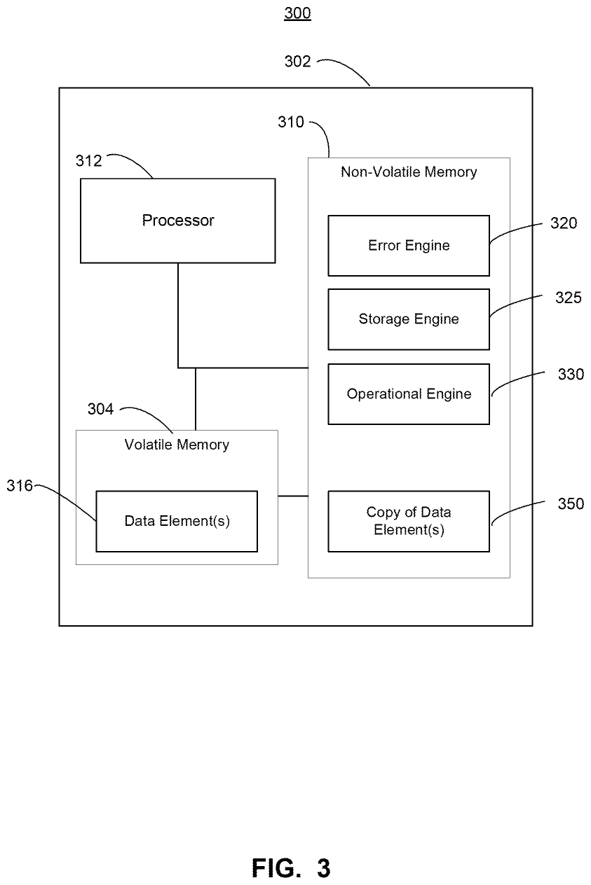

FIG. 3 is a block diagram of an example apparatus 300 for providing device operational mode blocking. Apparatus 300 may comprise a multi-function printer device 302 comprising a volatile memory 304, a non-volatile memory 310, and a processor 312. Volatile memory 304 may be configured to store a plurality of data elements 316. Device 302 may comprise and/or be associated with, for example, a general and/or special purpose computer, server, mainframe, desktop, laptop, tablet, smart phone, game console, printer, multi-function device, and/or any other system capable of providing computing capability consistent with providing the implementations described herein. Device 302 may store, in storage medium 310, an error engine 320, a storage engine 325, and an operational engine 330.

Each of engines 320, 325, 330 may comprise any combination of hardware and programming to implement the functionalities of the respective engine. In examples described herein, such combinations of hardware and programming may be implemented in a number of different ways. For example, the programming for the engines may be processor executable instructions stored on a non-transitory machine-readable storage medium, such as non-volatile memory 310, and the hardware for the engines may include a processing resource to execute those instructions. In such examples, the machine-readable storage medium may store instructions that, when executed by the processing resource, implement engines 320, 325, 330. In such examples, device 302 may comprise the machine-readable storage medium storing the instructions and the processing resource to execute the instructions, or the machine-readable storage medium may be separate but accessible to apparatus 300 and the processing resource.

Error engine 320 may detect an error condition blocking an operational mode of the apparatus and determine when the error condition that blocked the operational mode has been corrected. For example, error engine 320 may execute detect error condition instructions 120 to detect an error condition blocking an operational mode of a device 302. The operational mode may, for example, comprise a power-saving mode. The error condition may comprise, for example, a lack of a consumable supply, a power condition, and/or a component failure. For example, a print job may be in process when a consumable supply error, such as running out of paper, occurs. Error engine 320 may further execute detect error condition instructions 120 may determine whether the error condition that blocked the operational mode has been corrected. For example, an out-of-paper error may be corrected by detecting that paper has been loaded into device 302.

Storage engine 325 may store a copy 350 of each of a plurality of data elements 316 from the volatile memory 304 to the non-volatile memory 310. For example, storage engine 325 may execute store copy instructions 140 to store a copy of the at least one data element 316. For example, store copy instructions 140 may copy the at least one data element 316 from a volatile memory location such as volatile storage medium 304 to a non-volatile memory location such as non-transitory machine-readable medium 310. In such implementations, the print job data associated with data element 316 may be copied to the non-volatile storage medium 316 so that power may be reduced or eliminated to volatile storage medium 304 without losing data such as the current job status.

Upon the error engine 320 determining that the error condition that blocked the operational mode has been corrected, storage engine 325 may restore each of the plurality of data elements 316 from the stored copy 350 in the non-volatile memory 310 to the volatile memory 304. For example, storage engine 325 may execute store copy instructions 140 to restore the at least one data element 316 from the stored copy. For example, store copy instructions 140 may copy the stored data element from non-volatile storage medium 310 to volatile storage medium 304. In some implementations, a memory address of data element(s) 316 may be stored in the non-volatile storage medium 310 when the copy is stored so that data element(s) 316 may be restored to the same location in volatile storage medium 304 following the switch to a second operational mode. Following restoration of the at least one data element 316, store copy instructions 140 may delete the stored copy of the at least one data element 316.

Operational engine 330 may cause the apparatus 300 to enter the operational mode after the storage engine 325 stores the copy 350 of each of the plurality of data elements 316. Upon the error engine 320 determining that the error condition that blocked the operational mode has been corrected, operational engine 330 may cause the apparatus 300 to exit the operational mode. In some implementations, the operational mode may comprise a power-saving mode. In some implementations, exiting the power-saving mode may comprise entering a second operational mode comprising, for example, a processing mode associated with processing the at least one data element 316. For example, once device 302 switches to the processing mode and data element 316 has been restored to volatile storage medium 304, processing of the interrupted print job may resume.

In the foregoing detailed description of the disclosure, reference is made to the accompanying drawings that form a part hereof, and in which is shown by way of illustration how examples of the disclosure may be practiced. These examples are described in sufficient detail to allow those of ordinary skill in the art to practice the examples of this disclosure, and it is to be understood that other examples may be utilized and that process, electrical, and/or structural changes may be made without departing from the scope of the present disclosure.

What is claimed:

1. A non-transitory machine-readable medium storing instructions executable by a processor to:
detect an error condition blocking an operational mode of a device;
determine whether the operational mode will cause a loss of at least one data element; and
in response to determining that the operational mode will cause a loss of at least one data element:
store a copy of the at least one data element, and
cause the device to enter the operational mode.

2. The non-transitory machine-readable medium of claim 1, wherein the operational mode comprises a power-saving mode.

3. The non-transitory machine-readable medium of claim 1, wherein the at least one data element comprises data associated with a print job.

4. The non-transitory machine-readable medium of claim 1, wherein the instructions to store the copy of the at least one data element comprise instructions to copy the at least one data element from a volatile memory location to a non-volatile memory location.

5. The non-transitory machine-readable medium of claim 1, further comprising instructions to:
determine whether the error condition that blocked the operational mode has been corrected; and
in response to determining that the error condition that blocked the operational mode has been corrected:
cause the device to enter a second operational mode, and
restore the at least one data element from the stored copy.

6. The non-transitory machine-readable medium of claim 5, further comprising instructions to delete the stored copy of the at least one data element.

7. The non-transitory machine-readable medium of claim 5, wherein the at least one data element comprises a user identifier.

8. The non-transitory machine-readable medium of claim 7, further comprising instructions to notify a user associated with the user identifier that the at least one data element has been restored.

9. The non-transitory machine-readable medium of claim 7, wherein the second operational mode comprises a processing mode associated with processing the at least one data element.

10. The non-transitory machine-readable medium of claim 1, wherein the error condition comprises at least one of: a lack of a consumable supply, a power condition, and a component failure.

11. A method comprising:
detecting an error condition blocking an operational mode of a device;
storing a copy of each of a plurality of data elements;
causing the device to enter a power-saving mode;
determining whether the error condition that blocked the power-saving mode has been corrected; and
in response to determining that the error condition that blocked the power-saving mode has been corrected:
exiting the power-saving mode, and
restoring the plurality of data elements from the stored copies of each of the plurality of data elements.

12. The method of claim 11, wherein storing the copy of each of plurality of data elements comprises copying each of the plurality of data elements from a volatile memory location to a non-volatile memory location.

13. The method of claim 11, wherein restoring the plurality of data elements from the stored copies of each of the plurality of data elements comprises restoring the plurality of data elements in an order according to a priority of each of the plurality of data elements.

14. An apparatus, comprising:
a volatile memory, comprising:
a plurality of data elements;
a non-volatile memory, comprising:
an error engine to:
detect an error condition blocking an operational mode of the apparatus, and
determine when the error condition that blocked the operational mode has been corrected,
a storage engine to:
store a copy of each of a plurality of data elements from the volatile memory to the non-volatile memory, and
upon the error engine determining that the error condition that blocked the operational mode has been corrected, restore each of the plurality of data elements from the stored copy in the non-volatile memory to the volatile memory, and
an operational engine to:
cause the apparatus to enter the operational mode after the storage engine stores the copy of each of the plurality of data elements, and
upon the error engine determining that the error condition that blocked the operational mode has been corrected, cause the apparatus to exit the operational mode.

15. The apparatus of claim 14, wherein the operational mode comprises a power-saving mode.
